(19) United States
(12) Patent Application Publication
(10) Pub. No.: US 2005/0084597 A1
(43) Pub. Date: Apr. 21, 2005

(54) Methods for accelerating the production and maturation of distilled, uniquely flavored spirits

(76) Inventor: Richard D. Wasmund JR., Warrenton, VA (US)

Correspondence Address: Holland & Knight LLP;30th Floor, 131 S. Dearborn, Chicago, IL, 60603, US

(21) Appl. No.: 10/805,631

(22) Filed: Mar. 22, 2004

Related U.S. Application Data
(60) Provisional application No. 60/512,218, filed on Oct. 17, 2003.

(51) Int. Cl. C12C 1/00

(52) U.S. Cl. 426/592

(57) ABSTRACT

Factors that are critical to the preparation of wood products and useful for flavoring aqueous food products are disclosed. As a result of identifying these critical factors, the herein described process produces a wood product that transfers the desired flavor profile to the aqueous food product efficiently and economically. The resultant wood squares produce excellent flavor in ten percent, or less, of the time it takes for traditional aging.

### CROSS-REFERENCE TO RELATED APPLICATIONS

This application claims the benefit of U.S. Provisional Application No. 60/512,218, filed Oct. 17, 2003. Application Ser. No. 60/512,218, filed Oct. 17, 2003, is hereby incorporated herein by reference.

### BACKGROUND OF THE INVENTION

The present invention is generally directed to accelerated processes for producing distilled spirits with unique flavors.

The maturation of many potable beverages is accomplished by placing the liquid in wooden barrels, known as tight cooperage, where it remains for weeks, months or years depending on the desired level of maturation. All distilled spirits, for example, rum, scotch, whisky, brandy, and bourbon whisky, are perfectly colorless prior to the aging process. All color and a significant level of the flavor component for each beverage are derived from the time spent in contact with the wood of the body of the barrel. The aging of whiskies and brandies, in which years of maturation in contact with wood are required, results in the essential character of these products. Many woods contain flavor agents, or congeners, which are essential and desired for beverage maturation.

There are several drawbacks to using current aging processes. For example, there is a high inventory cost associated with the multi-year aging process. The ripening inventory must be stored in barrels, in places not subject to extreme temperature and humidity. Another detriment associated with the current aging methods is the loss of liquid during the aging process. Such loss of liquid can be due to evaporation, depending upon storage conditions.

Because of the potential benefits that could be derived from methods other than long term barrel aging, there have been significant attempts to find and use alternative methods of aging. For example, there have been various attempts involving the pretreatment of wood, such as charring, weathering, or boiling wood chips in water prior to use. None of these methods have been successful because of the unbalanced flavor and congener characteristics. Furthermore, for example, Tennessee whisky is filtered through a column (minimum of 10 ft.) of crushed sugar maple charcoal, prior to barreling. This process takes up to ten hours and adds no perceptible color. The specific flavor impact on the beverage is unknown. The wood is completely charred and in pieces of roughly 0.5 cubic inches.

Attempts have also been made to increase the surface area of wood by roasting small wood particles for subsequent use in a flavor transfer process. However, there is a risk that the desired spectrum of flavor in the wood will be lost due to the overly uniform roasting of the smaller wood particles.

Thus, there exists a continuing need to find an alternative to the age old maturation process that provides a flavorful beverage that makes use of the full spectrum of flavor available, that does not require a substantial period of time and is economical.

It is therefore an object of this invention to provide a unique process for flavoring liquids. It is another object of this invention to provide a process that allows easily reproducible standards for quality control and consistent maturation of liquid products.

It is a further object of this invention to provide a wood product that can be used to flavor beverages. It is a further object to provide a series of wood products able to impart different flavor characteristics to aqueous liquids.

### SUMMARY OF THE INVENTION

Factors that are critical to the preparation of wood products and useful for flavoring aqueous food products are disclosed. As a result of identifying these critical factors, the process disclosed here produces a wood product that transfers the desired flavor profile to the aqueous food product efficiently and economically. The disclosed wood preparation process requires that the seasoned wood be cut into slabs of thickness ranging from roughly 0.25 inches to roughly 5 inches and toasted at a temperature to allow the wood to char and crinkle on one or both sides, but remain uncharred at the center or at least one side. Such a charred product allows for the full range, or spectrum, of flavors that exist between the charcoal and the raw wood, to be captured and dissolved into the spirit/liquid. This is an excellent way to ensure accessibility to all of the flavors that exist at all levels of toasting within a single wood chip. The resultant wood squares produce excellent flavor in ten percent, or less, of the time it takes for traditional aging. Alternatively, the wood slab may be completely charred. Sugar maple is an example of wood that may be completely charred to impart a desired flavor to the liquid.

Examples of woods used in imparting flavor components to ethanol are white oak, red oak, chestnut oak, red or sweet gum, sugar maple, yellow or sweet birch, white ash, Douglas fir, beech, black cherry, sycamore, redwood, spruce bald cypress, basswood, and fruitwood. These are types of wood that may be used in the process disclosed herein and may be used in this, invention.

Some of these woods contribute flavors, in barreling processes, that are not generally recognized as desirable in flavoring beverages. For this reason, a preferred wood for use in this invention is fruitwood. Examples of fruitwood that may be used in the present invention are, but not limited to, apple wood, cherry wood, peach wood, pear wood, orange wood, mango wood, and grapefruit wood. The wood product is used to impart flavors to aqueous liquids by contacting the liquid with the wood product for a period sufficient to transfer the flavoring and/or coloring to the liquid and, in some instances, to permit chemical interactions in the liquid to reach a desired maturity.

### DETAILED DESCRIPTION OF THE INVENTION

As a result of identifying critical factors for the flavoring of aqueous food products, the process disclosed here produces a wood product that transfers the desired flavor profile to the aqueous food product efficiently and economically. The disclosed wood preparation process requires that the seasoned wood be cut into slabs, or squares, ranging in thickness from roughly 0.25 inches to roughly 5 inches and toasted at a temperature to allow the wood to char and crinkle on one or both sides, but remain uncharred at the center or at least one side. Such a charred product allows for the full range, or spectrum, of flavors that exist between the charcoal and the raw wood, to be captured and dissolved into the spirit/liquid.

The roasting process may require varying the temperature of the flame free surface to char the wood to the proper amount or degree in order to impart desirable flavor to the liquid. Apart from actually visualizing the degree to which the wood is being charred, it may be optimal to toast the wood on a flame free surface, wherein the temperature of the surface is in the range of from about 300° F. to 600° F. Acceptable results are obtained in about 2 minutes to about 10 minutes or more. Furthermore, the toasting conditions may be influenced by the size, thickness and/or moisture of the wood slab.

Whatever the variety of wood selected, the preferred wood retains as many volatiles and extractables as possible. It is preferable to use heartwood for the larger quantity of extractables often found in the heartwood portion of the tree. Seasoned wood, either air or kiln dried, is preferred. Freshly sawn wood may also be used. It is preferable that the resultant wood squares have a surface area ranging from roughly 1 square inch to 20 square inches. It is preferable that the wood squares range in thickness from approximately 0.25 inches to 5 inches. It is still preferable that the wood squares have a thickness of between approximately 0.3 inches and 3 inches. Further, it is still more preferable that the wood squares have a thickness of between approximately 0.5 inches and 1.5 inches.

A preferred wood for use in this invention is fruitwood. Examples of fruitwood that may be used in the present invention are, but not limited to, apple wood, cherry wood, peach wood, pear wood, orange wood, mango wood, and grapefruit wood. Fruitwood imparts unique palatable flavors to the liquid, and has not been heretofore used in the production or maturation processes of spirits. In addition to being used for the production of the wood squares described herein, such fruitwood may also be used in barrel-making for use in barrel-aging processes. The wood product is used to impart flavors to aqueous liquids by contacting the liquid with the wood product for a period sufficient to transfer the flavoring and/or coloring to the liquid and, in some instances, to permit chemical interactions in the liquid to reach a desired maturity.

The finished wood product may be used to flavor aqueous food products. The food products may be acidic liquid food products such as vinegar or acidic beverages such as carbonated beverages or fruit juices. The acidic liquid may be any liquid having a pH above about 1.0, preferably above about 2.0. The food products need not be acidic. Water with a neutral pH may be flavored and used to enhance the flavor of food products or as a component of a beverage.

A particularly useful embodiment of the invention is the use of the wood product to enhance the flavor of ethanolic liquids. In this embodiment, the wood product is contacted with an ethanol containing liquid during which desirable taste components react with oxygen, ethanol and water and are transferred from the treated wood particles to the ethanol containing liquid.

The ethanol containing liquid may be any liquid containing ethanol and water in specified proportions. Fermentation liquids, distillates or mixtures thereof or of synthetic ethanol and water may all be used. The base for the fermentation may be a grain such as corn, wheat, barley, rye or the like, a root or tuber such as potato or beet or the like, a fruit such as grape, apple, cherry, orange or the like or other plant part such as sugar cane, cactus or the like. The qualities of the final product are a function of the quality of the ethanol containing liquid as well as the wood chip used. The higher the quality of the ethanol containing liquid, the higher the quality of the final product. The particular ethanol containing liquids used, such as those ethanol containing liquids appropriate to each of the commonly recognized categories of beverages, such as whiskies of various types, rum, brandies, eau de vie, tequila, vodka, wines, fortified wines and liqueurs will provide different results when used with the same wood square. It is therefore necessary to match the particular ethanol containing liquid with a wood square having the desired flavoring qualities. The disclosed process may be used to make palatable marginal products as well as increasing the quality of excellent products. The ethanol content in the liquid may vary from 2% to 100%. It is preferable to maintain the ethanol content of the liquid from about 45% to about 85%. It is still more preferable to have the ethanol content at about 62.5%.

The liquid is introduced to the wood by immersion in large tanks and occasionally agitated with a mechanical stirrer or by using a circulating pump. This flavor transfer step may be conducted without agitation; however, agitation does increase efficiency and rate of the reaction. In the case where the liquid is wine, an unagitated reaction is preferred. It is preferable that the tanks be stainless steel; however, other well known inert materials, for example glass and plastics, may be used.

Other variations of the flavor transfer step include the provision of two or more different types of wood squares and concurrent or sequential contacting of the liquid with the wood particles. Thus, the liquid may be contacted with a first charge of one or more types of wood particles and then contacted with a second charge of the same or different type of wood particle or particles. Furthermore, it is preferable that food-grade cheesecloth be used to hold the wood particles, thereby functioning much like a “teabag” while it is immersed in the liquid.

Each batch of wood chips used to impart flavor and/or mature the liquid, may be recycled and used again in subsequent flavorings and/or maturation processes. If recycled once, i.e. used once in a flavoring or maturation process, the batch of wood chips is referred to as a “second generation” of wood chips. If recycled twice, the wood chip batch is referred to as a “third generation” of wood chips, and so on. The “first generation” of wood chips refers to the newly formed batch of wood chips yet to be used in a flavoring process.

Different generations of wood may also be used in the disclosed flavoring process. Newly produced new generation wood chips disseminate a sharper flavor to the liquid. However, it is an embodiment of this invention to reduce the “sharpness” of the flavor that is disseminated by the new wood chips. This is accomplished by using a combination of already used wood chips with the newly cut wood chips. For example, a mixture of first generation and second generation wood chips may be used in a single flavoring process. This combination will increase the complexity of flavor and more faithfully simulate the level of maturation that is normally acquired by years spent in a barrel.

There is no limit on the number of generations of wood chips that may be used in the disclosed flavoring and/or maturing processes. For example, first, second, and third generations of wood chips may be used in a single flavoring process or step. More generations used in a single flavoring process or step will produce a wider spectrum of flavors, while reducing the sharpness of any flavor contributed by the first generation of wood chips.

It is not necessary for the wood chips used in the mixture of generations be of the same type. As described above, each generation of chips have may be held in separate food-grade cheesecloth bags. The bags may then be immersed into the liquid. Alternatively, more than one generation of chip may be held in one bag.

The quantity of wood to volume of liquid can vary widely. It is generally useful to use a ratio of wood to liquid from about 7 g of wood (dry weight) per liter of liquid to about 15 g (dry weight) per liter of liquid. It is preferable that this ratio be used for each type of wood and/or each generation of wood. It is preferable that 11 grams of wood (dry weight) per liter of liquid be used for each type of wood and each generation of wood. The ratio of wood to liquid may be increased substantially if second, third, or fourth, etc., generations of wood are being used in the flavoring or aging process.

When the desired characteristics have been obtained the liquid is separated from the wood squares and transferred to inert containers for storage. The wood squares may be recycled and reused a number of times before their flavor enhancing ability is exhausted.

The following example further illustrates the invention. It will be understood, however, that the example is presented merely for the sake of illustration and does not limit the scope of the invention.

### EXAMPLE 1

### Use of Fruitwood to Impart Flavor and Smoothness

Seasoned applewood logs were obtained. The outer growth rings were trimmed away. The outer growth rings correspond to roughly 1-2 inches of the wood and bark. No chain saw cuts were left exposed. This eliminated any oil taste from the saw migrating into the liquid. The wood was cross cut into slabs ranging in thickness from roughly 0.5 to roughly 1.5 inches. This allowed the liquid (for example, whisky) to be absorbed and flow through the pores in the wood. The wood chips were subsequently toasted on a hot, stainless steel surface at a temperature to allow the wood to char and crinkle on one or both sides. The wood remains uncharred at the center, or, at least, on one side. The liquid (preferably spirits made to approximately 62.5% alcohol; normal barreling proof) was introduced to the wood by immersion in large tanks and occasionally agitated with a mechanical stirrer or by using a circulating pump. After the appropriate level of flavor and/or color was reached (up to one month), the process may be repeated with another type of wood chip, for example, white oak chips. As a final step, the product may be finished in a used bourbon barrel.

While the invention has been described n connection with a preferred method and procedure, it will be understood that it is not intended to limit the invention to this procedure. On the contrary, it is intended to cover all alternatives, modifications and equivalents as may be included within the spirit and scope of the invention as defined by the appended claims.

1. A method for improving the flavor of a liquid, comprising:
a) immersing fruitwood slabs in the liquid; and
b) agitating the liquid.

2. The method of claim 1, wherein the fruitwood slabs are cut from wood selected from the group consisting of apple wood, cherry wood, peach wood, pear wood, orange wood, mango wood, and grapefruit wood.

3. The method of claim 1, wherein the fruitwood slabs range in thickness from roughly 0.5 to 1.5 inches.

4. The method of claim 1, wherein the fruitwood slabs are toasted.

5. The method of claim 1, wherein the liquid is approximately 2% to 100% alcohol before the wood is immersed.

6. The method of claim 1, wherein the liquid is approximately 62.5% alcohol before the wood is immersed.

7. The method of claim 4, wherein the slabs are charred on one or both sides.

8. The method of claim 7, wherein the charred slabs remain uncharred in the center of the slab.

9. The method of claim 4, wherein the slabs are toasted to complete char.

10. The method of claim 7, wherein the slabs are charred on one side.

11. The method of claim 7, wherein the slabs are charred on both sides.

12. The method claim 1, wherein the slabs have a surface area of between approximately 1 square inch to 20 square inches.

13. The method of claim 1, wherein the slabs have a thickness of between approximately 0.3 inches and 3 inches.

14. The method of claim 1, wherein the slabs have a thickness of between approximately 0.5 inches and 1.5 inches.

15. The method of claim 1, wherein the fruitwood slabs are a mixture of first generation and second generation wood slabs.

16. The method of claim 15, further comprising third generation wood slabs.

17. The method of claim 1, wherein the fruitwood slabs are a mixture of first generation and third generation wood slabs.

18. A method for improving the flavor of a liquid, comprising:
a) immersing at least partly charred wood slabs in the liquid; and thereafter
b) agitating the liquid.

19. A flavored liquid wherein the flavored liquid is produced by the process of:
a) immersing fruitwood slabs in the liquid; and
b) agitating the liquid.

20. The flavored liquid of claim 19, wherein the flavor is selected from the group consisting of apple wood, cherry wood, peach wood, pear wood, orange wood, mango wood, and grapefruit wood.

21. The flavored liquid of claim 20, wherein the flavor is apple wood.

22. The flavored liquid of claim 19, wherein the liquid is 2% to 100% alcohol before the wood is immersed.

23. The flavored liquid of claim 19, wherein the liquid is 2% to 100% alcohol.

24. The flavored liquid of claim 19, wherein the liquid is approximately 62.5% alcohol before the wood is immersed.

25. The flavored liquid of claim 19, wherein the liquid is approximately 62.5% alcohol.
